(19) United States
(12) Patent Application Publication
(10) Pub. No.: US 2008/0204337 A1
(43) Pub. Date: Aug. 28, 2008

(54) PORTABLE ANTENNA DEVICE

(75) Inventors: Akira Takaoka, Okazaki-city (JP); Noriaki Okada, Chiryu-city (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); DENSO CORPORATION, Kariya-city (JP)

(21) Appl. No.: 12/068,486

(22) Filed: Feb. 7, 2008

(30) Foreign Application Priority Data
Feb. 22, 2007 (JP) 2007-42620

(51) Int. Cl. H01Q 1/36; H01Q 1/00

(52) U.S. Cl. 343/722; 343/895

(57) ABSTRACT

A portable antenna device includes a circuit board having a ground pattern, an antenna including a spirally wound external element and a spirally wound internal element coaxially disposed inside the external element at a distance from the first element so that one of the external and internal elements forms a signal wire and the other forms a ground wire. The circuit board includes plural passive elements each of which has a different impedance and a switch unit that selectively connects the antenna with the ground via one of the passive elements to provide a resonance characteristic of radio wave that has a frequency deference from a resonance characteristic provided by any other passive element.

### CROSS REFERENCE TO RELATED APPLICATION

The present application is based on and claims priority from Japanese Patent Application 2007-42620, filed Feb. 22, 2007, the contents of which are incorporated herein by reference.

### BACKGROUND OF THE INVENTION

1. Field of the Invention

The present invention relates to an antenna device to be mounted in a portable communication device such as a device used in a keyless entry system or a remote control system mounted in a house or a vehicle.

2. Description of the Related Art

In such a system that uses a comparatively long wave length (e.g. between centimeters and meters) in a band of UHF or VHF, the size of an antenna device is a dominant factor to the size of a portable communication device.

JP-2003-152427-A discloses a compact antenna device that is comprised of a straight rod-shaped internal conductor and a spirally wound external conductor that surrounds the internal conductor.

However, the straight rod-shaped internal conductor is an obstacle to reduction in the height of the antenna device because the length of at least one of the internal and the external conductors in the direction perpendicular to the rod-shaped internal conductor must be increased in order to reduce the size of the antenna device while securing an electrical length of resonance. In addition, because the keyless entry system usually adopts a single radio wave (narrow band) such as ASK (amplitude-shift keying) or FSK (frequency-shift keying), this antenna device can be only used for communication by a single radio wave. Therefore, it may be difficult to demodulate a received signal if it includes a noise of a similar-frequency.

### SUMMARY OF THE INVENTION

Therefore, an object of the invention is to provide a more compact antenna device.

Another object of the invention is to provide a compact antenna device that can be used for communication by plural radio waves.

According to a feature of the invention, an antenna device includes a circuit board having a ground pattern, an antenna including a spirally wound external element extending vertically from the circuit board and a spirally wound internal element coaxially disposed inside the external element at a distance from the first element and extending vertically from the circuit board so that one of the external and internal elements forms a signal wire and the other forms a ground wire. The circuit board includes a plurality of passive elements each having a different impedance and a switch unit for inserting one of the passive elements between the antenna and the ground to provide a resonance characteristic of radio wave that has a frequency deference from a resonance characteristic provided by any other passive elements.

Because the internal element is wound to be spiral so as to confront the spirally wound external element, a secondary or image current that is induced by the external element flows in the same as primary current flowing in the internal element. Therefore, the secondary current can be effectively added to the primary current as a vector sum. In addition, noise current is prevented from flowing in the internal element.

If one of the passive elements includes a capacitance, the inductance of the antenna is canceled, so that the resonance frequency can be shifted to a higher band. On the other hand, the resonance frequency can be shifted to a lower band if one of the passive elements includes an inductance.

In the above antenna device, it is preferable that the external element is connected with the ground pattern and that the frequency difference is 25 MHz or more than 25 MHz.

According to another feature of the invention, an antenna device includes a circuit board having a ground pattern, an antenna including a spirally wound external element extending vertically from the circuit board and a spirally wound internal element coaxially disposed inside the external element at a distance from the external element and extending vertically from the circuit board so that the internal element forms a signal wire and the external element forms a ground wire, wherein the circuit board includes a first passive element connected with the external element, a second passive element connected with the external element, a first switch connected between the first passive element and a ground pattern and a second switch connected between the second passive element and the ground pattern and wherein the first and second switches are driven to selectively connect one of the first and second passive elements between the external element and the ground pattern to provide a resonance characteristic of radio wave that has a frequency deference from a resonance characteristic provided by the other passive element.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a perspective view of a main portion of an antenna device according to the first embodiment of the invention;

FIG. 2 is an enlarged side view of the main portion of the antenna device;

FIG. 3 is an equivalent circuit diagram of the antenna device;

FIG. 4 is a graph showing a relation between frequencies of radio waves and the voltage standing-wave ratios; and

FIG. 5 is an equivalent circuit diagram of an antenna device according to the second embodiment of the invention.

### DETAILED DESCRIPTION OF THE PREFERRED EMBODIMENTS

Two preferred embodiments according to the present invention will be described with reference to the appended drawings.

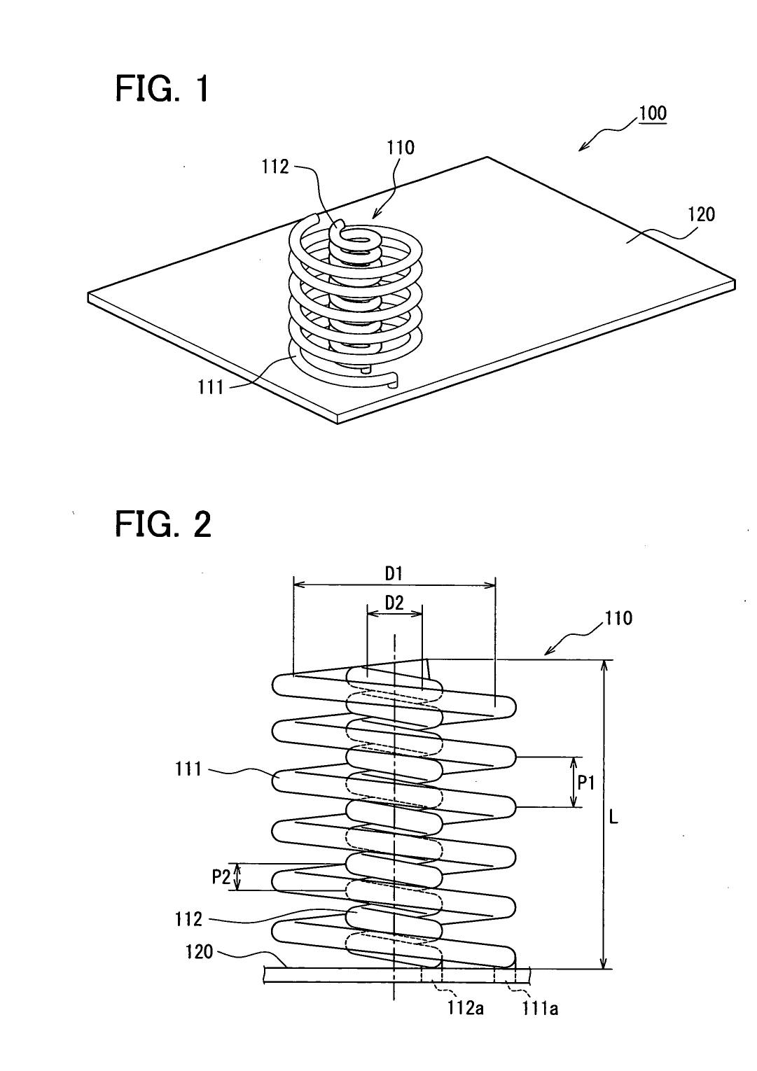

An antenna device according to the first embodiment of the invention will be described with reference to FIGS. 1-4.

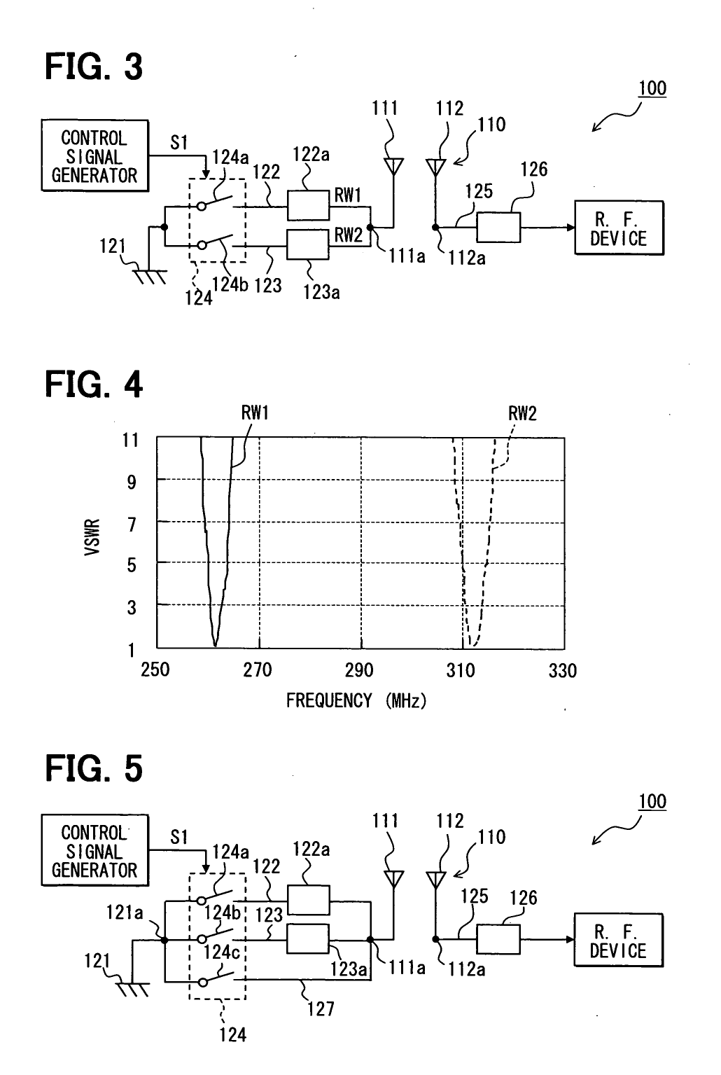

As shown in FIG. 1, the antenna device 100 according to the first embodiment of the invention includes an antenna 110 disposed on a circuit board 120, on which a ground (GND) pattern 121 (shown in FIG. 3) is formed. The antenna 110 includes an external element 111 and the internal element 112 that is coaxially disposed inside the external element 111 to be parallel with each other via air, resinous member, ceramics member or other member of dielectric material. The external element 111 is made of a steel wire having an outside diameter of 1.2 mm which is spirally wound at a pitch P1 to have an inside diameter D1. The internal element 112 is made of the same steel wire which is spirally wound at a smaller pitch P2 than the pitch P1 to have an inside diameter D2 that is smaller than D1. Incidentally, the cross section of the spirally wound external and internal elements may be circular, rectangular or any other polygonal shape.

As shown in FIG. 2, both the external element 111 and the internal element 112 have substantially the same height L from the circuit board 120. The external element 111 has one end 111a that is bent to vertically project to be inserted into a through hole of the circuit board 120, thereby fixing the external element 111 to the circuit board 120. The internal element 112 has one end 112a that is also bent to vertically project to be inserted into another through hole of the circuit board 120, thereby fixing the internal element 112 to the circuit board 120. The end 111a of the external element 111 is electrically connected with the GND pattern 121, and the end 112a of the internal element 112 is electrically connected with a lead wire 125, which is also formed on the circuit board 120. The external and internal elements 111, 112 may be fixed to the circuit board 120 by an antenna holder, as disclosed in Japanese Patent Application 2006-038500 or US 2007/0200786 A1. The external and internal elements 111, 112 may be connected with a land that is formed on the circuit board 120 by means of surface mounting.

As shown in FIG. 3, a first circuit 122 having a first passive component 122a, such as a capacitor of 1000 pF and a second circuit 123 having a second passive component 123a such a capacitor of 1 pF are formed between the end 111a of the external element 111 and the GND pattern 121. A switch unit 124 that includes a first switch 124a and a second switch 124b is disposed between the GND pattern 121 and the two passive components 122a, 123a. The second passive component 123a may be an inductor or a capacitor of different capacity from the first passive component in case the first passive component 122a is a capacitor.

The first switch 124a is connected between the GND pattern 121 and the first passive component 122a, and the second switch 124b is connected between the GND pattern 121 and the seconds passive component 123a. The first and second switches 124a, 124b are driven by an output signal S1 of a control signal generating circuit. The output signal is generated based on a clock signal, so that one of the first and second switches closes while the other opens. In other words, the external element 111 is connected with the GND pattern 121 via either one of the first and second circuits 122, 123. Accordingly, the antenna 110 provides two different radio waves to communicate with a central unit of a keyless entry system or a remote control system.

Incidentally, the keyless entry system is using a radio wave of 312.15 MHz for the amplitude modulation (AM) and a radio wave of 314 MHz for the frequency modulation (FM) at present. However, the key less entry system can use other radio wave without a license if its frequency is between 222 MHz and 322 MHz.

As shown in FIG. 4, there is a frequency difference of about 50 MHz between two radio waves RW1, RW2. Therefore, it is comparatively easy to demodulate the received signal even if it includes a noise having a frequency that is similar to one of the two radio waves. It has been found by the inventor that the noise trouble can be prevented by the effect of frequency diversity if the difference in frequency between the two radio waves is 25 MHz or more. A data examination circuit may be mounted on the circuit board 120 to change the first and second switches 124a, 124b one from the other if the data examination circuit finds a data error, thereby changing the communication frequency.

In the circuit board 120, the lead wire 125 is connected with the one end 112a of the internal element 112. A signal received by the internal element 112 is transmitted via an impedance matching element (e.g. capacitor) 126 to an R.F. (radio frequency) device. The R.F. device is disposed outside the circuit board 120. However, it may be mounted on the circuit board 120. The capacitance of the impedance matching element 126 is changed from 3 pF to 12 pF when the radio wave RW1 is switched to the radio wave RW2 in order to have steep resonance characteristics. The capacitance is effective to prevent reduction in the radiant efficiency of the antenna 110, so that the size of the antenna can be reduced. It has been found that the antenna directivity changes as the resonance frequency changes, so that a stable keyless entry system can be provided.

An antenna device according to the second embodiment of the invention will be described with reference to FIG. 5.

As shown in FIG. 5, the construction is almost the same as the first embodiment except that the switch unit 124 further includes a third switch 124c, which is connected between the end 111a of the external element 111 and the GND pattern 121 by a third circuit 127. The first, second and third switches 124a, 124b, 124c are driven by the output signal S1 of the control signal generating circuit so that one of the three switches 124a, 124b, 124c closes while the others open. In other words, the external element 111 is connected with the GND pattern 121 via one of the first, second and third circuits 122, 123, 127. Accordingly, the antenna 110 provides three radio waves to communicate with a central unit of the keyless entry system or a remote control system.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. An antenna device comprising:
a circuit board having a ground pattern;
an antenna including a spirally wound external element extending vertically from the circuit board and a spirally wound internal element coaxially disposed inside the external element at a distance from the external element and extending vertically from the circuit board so that one of the external and internal elements forms a signal wire and the other forms a ground wire,
wherein the circuit board comprises a plurality of passive elements each having a different impedance and a switch unit for inserting one of the passive elements between the antenna and the ground to provide a resonance characteristic of radio wave that is deferent from a resonance characteristic provided by any other passive elements.

2. An antenna device as in claim 1, wherein the external element is connected with the GND pattern.

3. An antenna device as in claim 1, wherein the frequency difference is 25 MHz or more than 25 MHz.

4. An antenna device as in claim 1, wherein the switch unit comprises a plurality of switches each of which is connected between one of the passive elements and the ground pattern.

5. An antenna device comprising:
a circuit board having a ground pattern;
an antenna including a spirally wound external element extending vertically from the circuit board and a spirally wound internal element coaxially disposed inside the external element at a distance from the external element and extending vertically from the circuit board so that the internal element forms a signal wire and the external element forms a ground wire,
wherein: the circuit board comprises a first passive element connected with the external element, a second passive element connected with the external element, a first switch connected between the first passive element and a ground pattern and a second switch connected between the second passive element and the ground pattern; and
the first and second switches are driven to selectively connect one of the first and second passive elements between the external element and the ground pattern to provide a resonance characteristic of radio wave that has a frequency deference from a resonance characteristic provided by the other passive element.
